(19) United States
(12) Patent Application Publication
(10) Pub. No.: US 2024/0140513 A1
(43) Pub. Date: May 2, 2024

(54) SHOPPING CART GATE WITH PROTECTIVE BUMPER

(71) Applicant: TARGET BRANDS, INC, Minneapolis, MN (US)

(72) Inventors: Sara L. Pedersen, Minneapolis, MN (US); Alex K. Poniatowski, New Hope, MN (US); Hermann Eichele, Leipheim (DE); Stefan Remmele, Offingen (DE); Dieter Stöckle, Landensberg (DE); Thomas Gasche, Leipheim (DE); Peter Irlbacher, Schwarzenfeld (DE); Johann Daminger, Neu-Ulm (DE); William Kiser, Lincolnton, NC (US)

(73) Assignee: TARGET BRANDS, INC, Minneapolis, MN (US)

(21) Appl. No.: 18/383,870

(22) Filed: Oct. 25, 2023

Related U.S. Application Data
(60) Provisional application No. 63/419,705, filed on Oct. 27, 2022.

(51) Int. Cl. B62B 5/00

(52) U.S. Cl. CPC B62B 5/0006; B62B 3/18

(57) ABSTRACT

A shopping cart comprises a chassis, wheels, and a basket. The chassis includes a base frame and support masts extending upwardly from the base frame. The wheels are coupled to the chassis. The basket is supported by the support masts to extend over the chassis, wherein the basket defines a compartment for selectively storing items. The base frame defines an exterior facing surface having a bumper extending outwardly away from a remainder of the exterior facing surface providing a buffer of space between an exterior bumper surface and a remainder of the base frame.

### CROSS-REFERENCE TO RELATED APPLICATIONS

This non-provisional utility application is related to and claims priority under 35 U.S.C. 119(e) to U.S. Provisional Patent Application No. 63/419,705, filed Oct. 25, 2022, which is incorporated herein by reference.

### BACKGROUND OF THE INVENTION

Stores around the world maintain fleets of shopping carts to facilitate a customer's selection, transport, and purchase of goods within those stores. Over many decades, the shape and size of shopping carts have changed to meet different models of shopping. Retailers devote considerable resources to shaping a customer's experience within a retail store to make shopping easier, more comfortable, and attractive. The impact of shopping carts on that experience is often overlooked. While the predominate functions of shopping carts are storage and transport, it is often desired that these functions are achieved in an aesthetically pleasing, but robust package that can withstand the typical bumps and other trials encountered during daily use.

For example, during regular use, a typical shopping cart is often scraped along, bumped into, slide along, or otherwise pushed or otherwise moved into contact with other shopping carts, product storage fixtures, point-of-sale terminal surrounds, stocking carts, walls, and/or other permanent or movable fixtures within a retail store. In other instances, shopping carts may also contact vehicles, curbs, rocks, potholes, roadside features, etc. when they are used in an adjacent parking lot or ramp to the retail store. Contact with other structures either once or on multiple occasions over time can cause damage to a shopping cart, marring the overall appearance of the shopping cart in an undesired manner.

### SUMMARY

A shopping cart comprising a chassis, wheels, and a basket. The chassis includes a base frame and support masts extending upwardly from the base frame. The wheels are coupled to the chassis. The basket is supported by the support masts to extend over the chassis, wherein the basket defines a compartment for selectively storing items. The base frame defines an exterior facing surface having a bumper extending outwardly away from a remainder of the exterior facing surface providing a buffer of space between an exterior bumper surface and a remainder of the base frame to facilitate protecting the shopping cart from surrounding objects.

Other shopping carts, bumpers, associated assemblies, and associated methods are also described.

### BRIEF DESCRIPTION OF THE DRAWINGS

Embodiments of the invention will be described with respect to the figures, in which like reference numerals denote like elements, and in which:

FIG. 1 is a right side and rear perspective view illustration of a shopping cart, according to an embodiment of the invention.

FIG. 2 is an enlarged, detail of a bottom portion of the shopping cart of FIG. 1, according to an embodiment of the invention.

FIG. 3 is a front view illustration of the shopping cart of FIG. 1, according to an embodiment of the invention.

FIG. 4 is a rear view illustration of the shopping cart of FIG. 1, according to an embodiment of the invention.

FIG. 5 is right side view illustration of the shopping cart of FIG. 1, according to an embodiment of the invention.

FIG. 6 is a top view illustration of the shopping cart of FIG. 1, according to an embodiment of the invention.

FIG. 7 is a cross-sectional view illustration of the shopping cart of FIG. 1 taken along the line 7-7, according to an embodiment of the invention.

FIG. 8 is a cross-sectional view illustration of the shopping cart of FIG. 1 taken along the line 8-8, according to an embodiment of the invention.

FIG. 9 is a cross-sectional view illustration of the shopping cart of FIG. 1 taken along the line 9-9, according to an embodiment of the invention.

FIG. 10 is a front view illustration of the shopping cart of FIG. 1 next to an adjacent fixture, according to an embodiment of the invention.

FIG. 11 is a partial right side view illustration of the shopping cart of FIG. 1 next to an adjacent fixture, according to an embodiment of the invention.

### DETAILED DESCRIPTION

The following detailed description of the invention provides example embodiments and is not intended to limit the invention or the application and uses of the invention. Furthermore, there is no intention to be bound by any theory presented in the preceding background of the invention or the following detailed description of the invention. Relational terms herein such a first, second, top, bottom, etc. may be used herein solely to distinguish one entity or action from another without necessarily requiring or implying an actual such relationship or order. Directional terminology, such as “front,” “back,” “leading,” or trailing is used with reference to the orientation in the figure(s) being described. Any directional terminology is used for purposes of illustration and is in no way limiting. In addition, as used herein, the terms “about” or “substantially” apply to all numeric values or descriptive terms, respectively, and generally indicate a range of numbers or characteristics that one of skill in the art would consider equivalent to the recited values or terms, that is, having the same function or results.

Embodiments of the invention are directed to a shopping cart a including, for example, a chassis, wheels, and a basket. The chassis includes a base frame and support masts extending upwardly from the base frame with wheels being coupled to the chassis. The basket is supported by the support masts to extend over the chassis, wherein the basket defines a compartment for selectively storing items. The base frame defines an exterior facing surface having a bumper extending outwardly away from a remainder of the exterior facing surface providing a buffer of space between an exterior bumper surface and a remainder of the base frame.

In different embodiments, the bumper extends axially along a length of one or more of a front cross bar or side strut of the base frame, the support masts, and/or the rear legs, which support rear wheels, providing spacing from any object, e.g., fixture, person, building feature, parking lot cub, automobile, etc., that may be contacted and contact between that object and any other portion of the shopping cart other than the bumper. In this manner, bumper takes on the contact and any of the damage that contact with object(s) may cause limiting the aesthetic impairment to the shopping cart to the relatively small part of the cart that forms the bumper. As such, the overall aesthetic integrity and lifespan of a shopping cart can be increased. Bumper can be formed of a variety of manners, but in one embodiment, is integrally form via injection molding as a single piece with base frame, support masts, and/or rear legs, as will be apparent to those of skill in the art upon reading the present application. Other embodiments, variations, and associated methods are further described below.

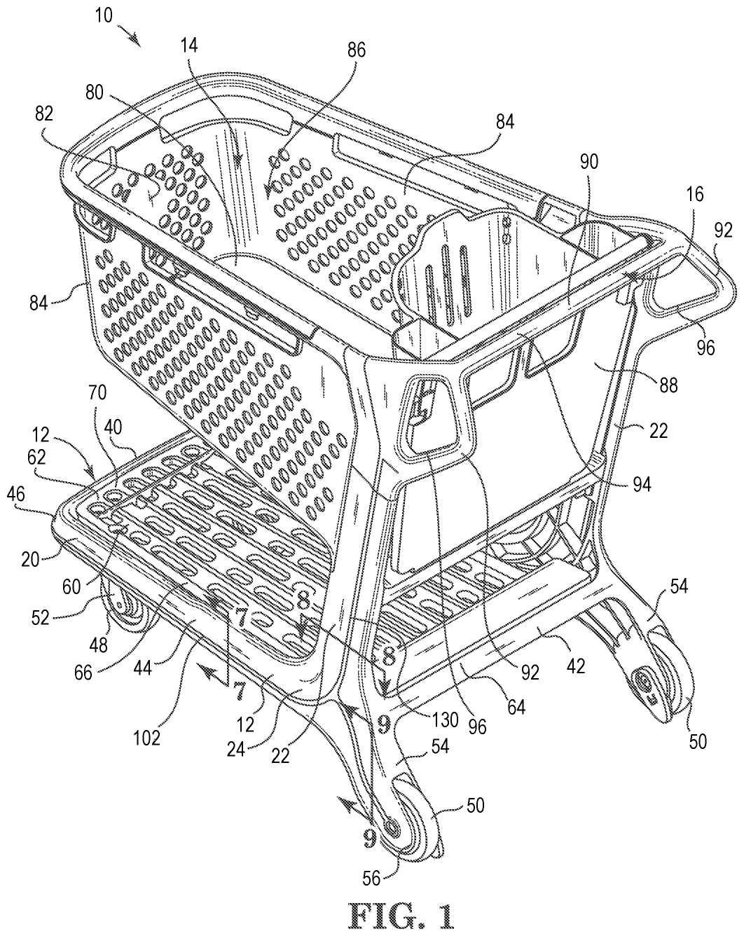

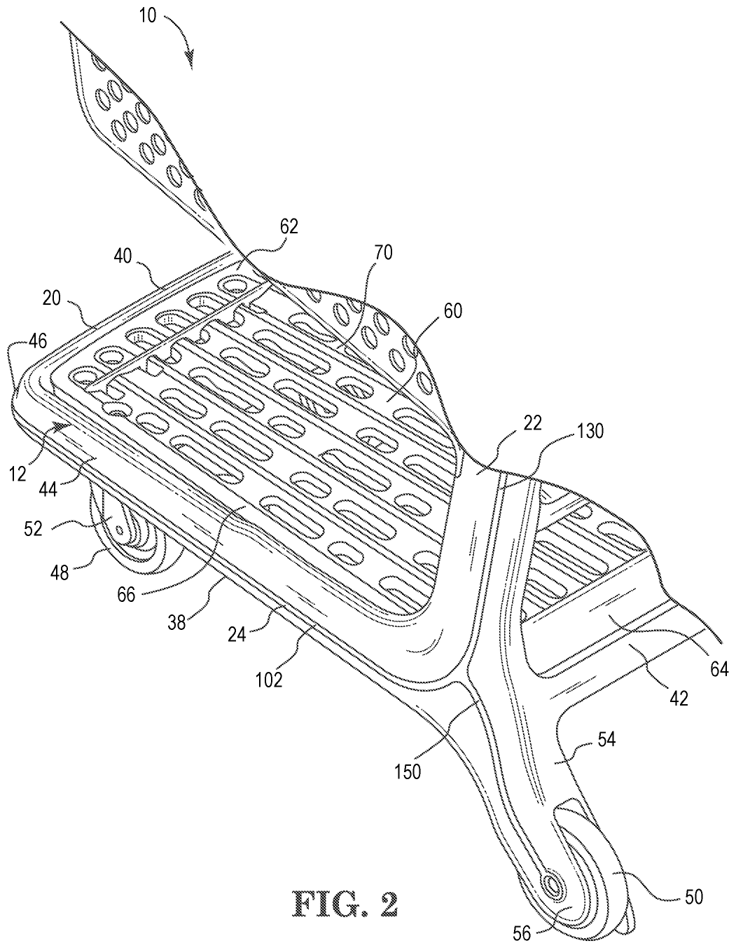

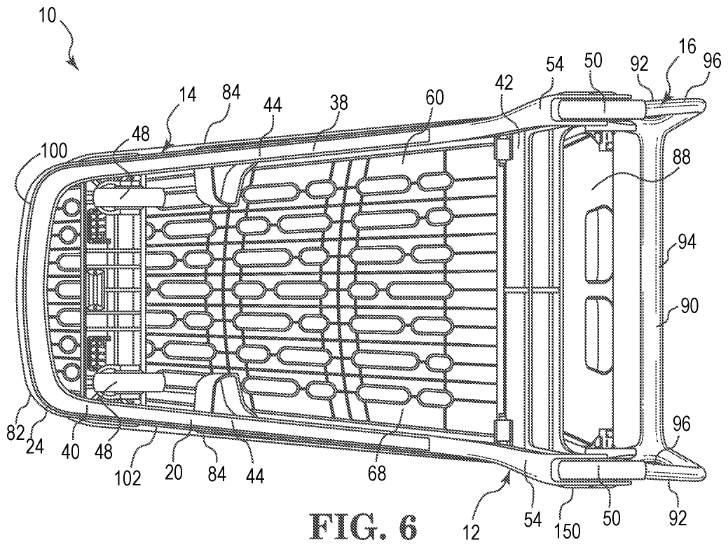

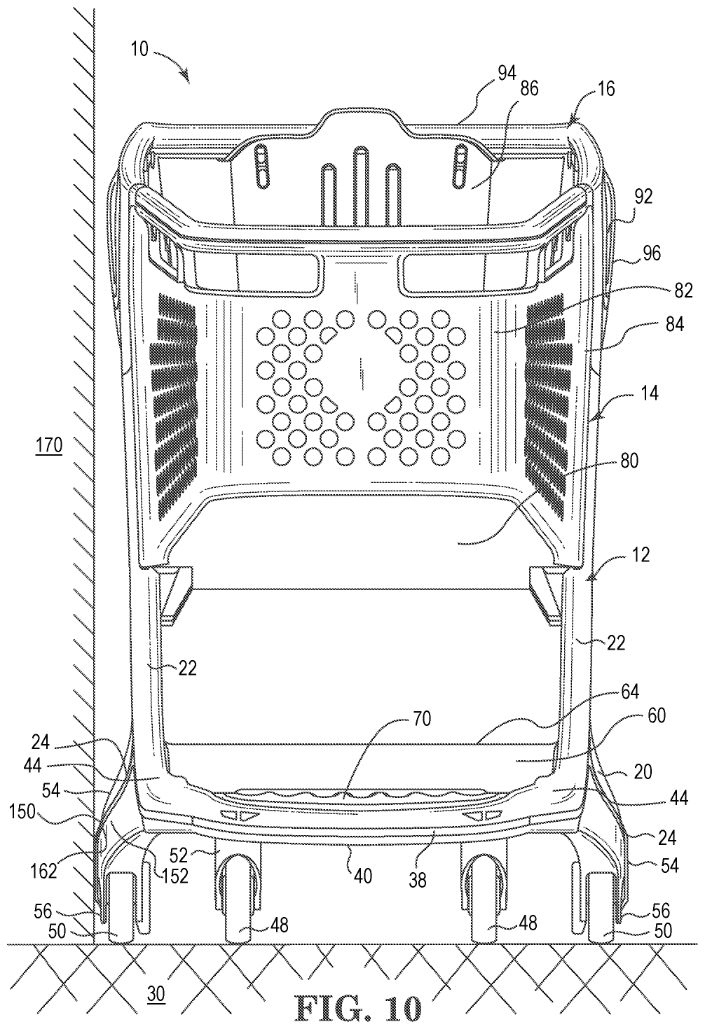

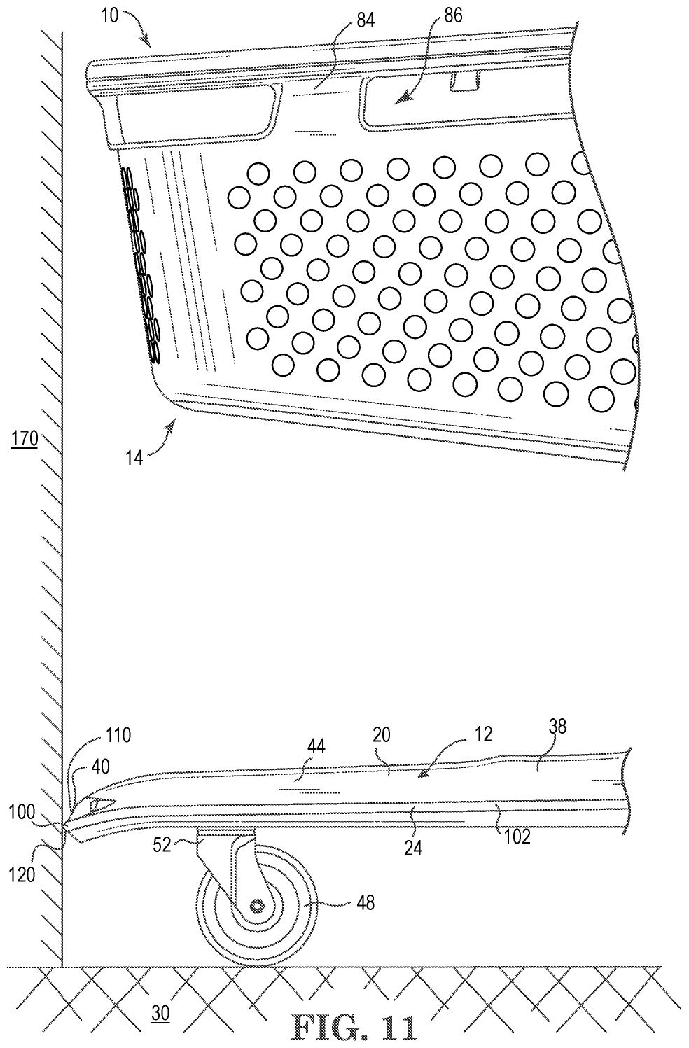

Turning to the figures, FIGS. 1-6 illustrate a shopping cart 10, according to one embodiment of the invention, including a chassis 12, a basket 14 supported by chassis 12, and a handle assembly 16 to facilitate a user in manipulating movement of shopping cart 10. Frame 10 includes a wheeled chassis or base 20 for interacting with a floor, ground, or other supporting surface 30 (see FIGS. 10-11), and support masts 22 extending upwardly from wheeled base 20 to receive basket 14 opposite and spaced above wheeled base 20. In one embodiment, support masts 22 extend upwardly from a rear of wheeled base 20, and basket 14 cantilevers over wheeled base 20 from an end of support masts 22 opposite wheeled base 20. Per one example of the invention, support chassis 12 includes one or more bumpers 24 formed to extend outwardly from a remainder of support chassis 12 providing a contact buffer and/or spacer from other objects and the remainder of support chassis 12.

As will be described in further detail below, the one or more bumpers 24 are configured to selectively contact other objects etc. in a retail setting and to generally prevent or decrease contact between those other objects and the remainder of the support chassis 12 and/or other portions of shopping cart 10 in a manner that generally preserves the integrity and aesthetic appeal of the remainder of the support chassis 12 and other portions of shopping cart 10 even after shopping cart 10 is pushed other otherwise moved into contact with other shopping carts 10, fixtures, or other surround objects in the retails setting, adjacent parking lot, or other related areas.

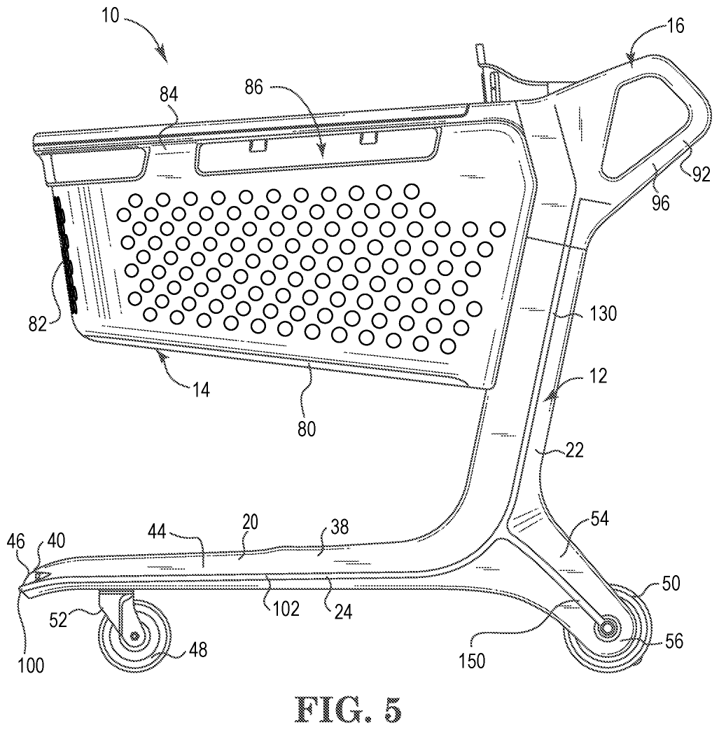

Wheeled base 20 generally extends horizontally in any desirable size and shape, for example, in a generally elongated trapezoidal shape, and is positioned between basket 14 and supporting surface 30, forming the main support for shopping cart 10. In one embodiment, wheeled base 20 includes a front cross bar 40 and a rear cross bar 42, which are each spaced apart from one another and laterally extend across a substantial entirety of a width of the wheeled base 20, for example, between opposing longitudinally extending side struts 44 each extending from and between a front and rear of wheeled base 20, for example, front cross bar 40 and rear cross bar 42. Front cross bar 40, rear cross bar 42, and side struts 44 collectively define a frame 38 of wheeled base 20. As illustrated with reference to FIG. 5, in one embodiment, front cross bar 40 extends between opposing side struts 44 with an angled orientation to form a rearwardly tapered ramped front surface 46 thereof.

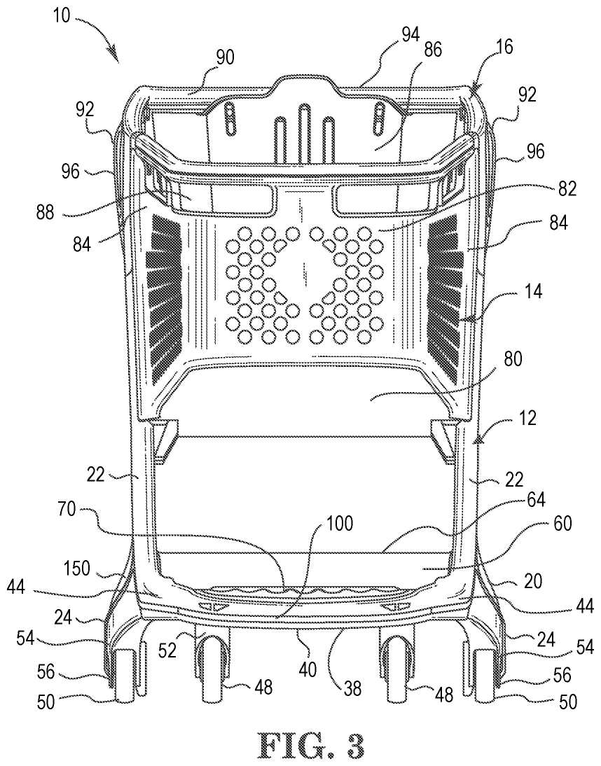

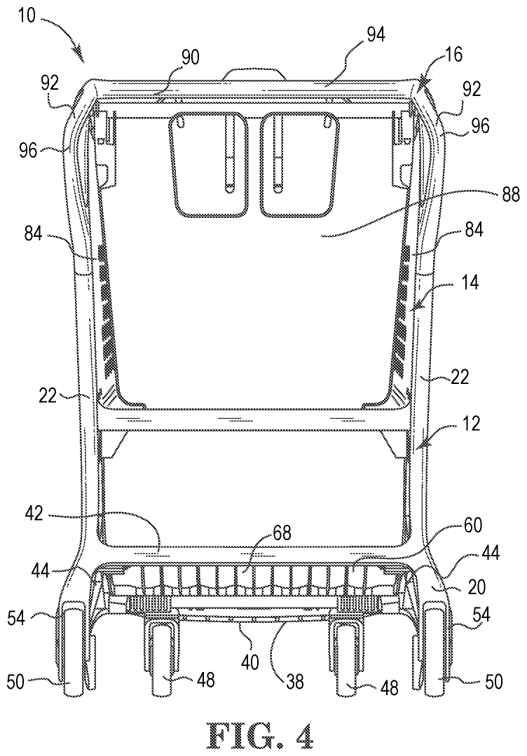

Since, in one embodiment, wheeled base 20 has a general trapezoidal shape, side struts 44 generally are not positioned to run parallel to each other, but instead taper away from each other as they extend from the front to the rear of shopping cart 10. In this manner a front of wheeled base 20 is less wide that a rear of wheeled base 20. In one example, shopping cart 10 includes two sets of wheels, that is, front wheels 48 and rear wheels 50. Front wheels 48 may be secured to wheeled base 20 within the overall footprint of wheeled base 20 near a front of wheeled base 20, in one example, via front legs 52, which may simply by casters, coupled to a bottom support of wheeled base 20. In one embodiment, support frame 14 additionally or alternatively includes two rear legs 54. Each rear leg 54 extends rearwardly and/or outwardly, for instance, both rearwardly and outwardly as well as downwardly to support surface 30 (FIGS. 10 and 11) from the intersection between wheeled base 20 and a different one of support masts 22 to a free end 56 of rear leg 54 where it is rotatably coupled with a rear wheel 50. In this embodiment, rear wheels 50 are spaced apart from each other a considerably wider distance than front wheels 48 as most easily seen viewing the front and back views of shopping cart 10 in FIGS. 3 and 4.

In one example, shopping cart 10 additionally includes a tray 60 supported by and positioned on top of wheeled base 20, namely partially by one or more of each of front cross bar 40, rear cross bar 42, and side struts 44. More specifically, tray 60 may include a front edge 62, a rear edge 64 opposite front edge 62, and opposing longitudinal sides 66 of tray 60 each extending between front edge 62 and rear edge 64. Tray 60 may be substantially planar, have grooves, be solid, per perforated (e.g., to allow for drainage of any liquids or other items spilled on tray 60), or have any other suitable form. In one instance, tray 60 defines a bottom surface 68 facing toward support surface 30 and a top surface 70 facing in a direction opposite bottom surface 68.

In one example, shopping cart 10 includes two support masts 22 each extending upwardly and, in one embodiment, slightly rearwardly, from wheeled base 20 to an opposite top end 80 of each support mast 22. In one embodiment, each support mast 22 extends from a different lateral side of wheeled base 20, for example, extending from an intersection between one of side struts 44 and a different, adjacent one of rear legs 54. Each support mast 22 may be formed integrally, for example, as a single injection molded piece with frame 38 and/or rear legs 54 of wheeled base 20, as a separate piece later coupled with frame 38, or otherwise coupled with shopping cart 10, as will be apparent to those of skill in the art upon reading the present application.

In one example, basket 14 is slide onto or otherwise coupled to top portions of each of and extends between the two support masts 22. Basket 14 defines a bottom panel 80, a front panel 82, and two opposing side panels 84 collectively defining an internal compartment 86 for holding items for a guest as they shop within a retail setting and/or as they transport items from the retail setting to and from his or her vehicle for transport to or from the retail setting. In one embodiment, basket 14 or other portion of shopping cart 10 includes a static or rotatably movable back panel 88 covering a side of internal compartment opposite front panel 82. Back panel 88 may be rotatably to act as a rear gate rotatable about a substantially horizontal axis as will be apparent to those of skill in the art upon reading the current application, for example, as are common to facilitate horizontal stacking of multiple shopping carts 10 together.

Shopping cart 10 may also include handle assembly 26 at any one of various or multiple positions on shopping cart 10 to facilitate manipulating, e.g., pushing and/or pulling, and moving shopping cart 10. As used herein and illustrated in the drawings, the front of shopping cart 10 is the portion of basket 14 that generally leads shopping cart 10 during forward movement of shopping cart 10 induced by a user pushing on handle assembly 16 toward basket 14 from a position on shopping cart 10 opposite basket 14, and the rear of shopping cart 10 is the trailing portion of basket 14 or outside basket 14 opposite front of shopping cart 10 during the above-described forward movement of shopping cart 10, for example, including handle assembly 16.

Handle assembly 16 includes one or more of a rear, laterally-extending handle 90 and two or more side handles 92, in one embodiment. Laterally-extending handle 90 extends behind back panel 88 laterally across a top of shopping cart 10, for example, in a substantially linear manner providing an elongated grasping zone 94 of a user to interact with laterally-extending handle 90 to apply force or forces to shopping cart 10 manipulating movement thereof. In one embodiment, handle assembly 16 additionally or alternatively includes side handles 92, for example, one atop each of support masts 22, each providing an additional grasping zone 96 for facilitating inducing movement and steering of shopping cart 10, as will be apparent to those of skill in the art upon reading the present application.

In one embodiment, each of support chassis 12, basket 14, handle assembly 16, and/or tray 60 are separately made exclusively of a plastic or other moldable material. This arrangement enables a lightweight cart while providing numerous structural, performance, and ergonomic functions. In another embodiment, one or more of support chassis 12, basket 14, handle assembly 16, tray 60, and/or additional components of shopping cart 10 is/are made of a material other than a plastic material, such as metal or other suitable materials as will be apparent to those of skill in the art. In one embodiment, each of support chassis 12, basket 14, handle assembly 16, and/or tray is made from the same one or different ones of a nylon material, a high-density polyethylene (HI)PE) material, or other moldable materials or mixtures of moldable materials and/or other non-moldable materials. Still further, use of wire, metal, or any other materials to completely or partially form any one or more of support chassis 12, basket 14, handle assembly 16, and/or tray 60 are also contemplated as will also be apparent to those of skill in the art upon reading this application.

Returning to the details of chassis 12, chassis 12, according to one embodiment of the invention, chassis 12 is integrally formed to include bumper 24, for example, via injection molding as a single piece of material. Bumper 24 may take on any one of a variety of configurations designed to provide spacing between a remainder of chassis 12 and other objects 170 (see FIGS. 10 and 11) outside of shopping cart 10. In one embodiment, bumper 24 is configured to surround at least three sides of a perimeter of frame 38, for example, extending across a majority of a length of each of the opposing side struts 44 and front cross bar 40. More particularly, in one example, front cross bar 40 is injection molded to define a front segment 100 of bumper 24, and side struts 44 are each injection molded to define side longitudinal segments 102 of bumper 24.

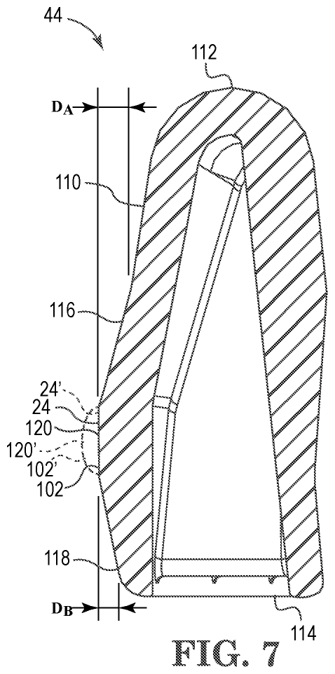

Referring FIGS. 1-6 and additionally to the cross-sectional view of FIG. 7 taken about the line 7-7 in FIG. 1, in one embodiment, side strut 44 defines an exterior facing surface 110 extending between a top 112 and a bottom 114 of side strut 44 opposite top 112. Side strut 44 may be hollow as shown in FIG. 7 or, in other embodiments, is solid or otherwise formed. Exterior surface 110 defines a top taper portion 116, longitudinal side segment 102 of bumper 24, and bottom taper portion 118, in one embodiment. More specifically, in one example, exterior surface 110 extends downwardly from top 112 to top taper portion 116, where exterior surface 110 angles downwardly and further outwardly away from a top 112, and away from compartment 86, to one of longitudinal side segments 102 of bumper 24. In this manner, a distance D_{A} is created between longitudinal side segment 102 of bumper 24 and a remainder of chassis 12 (FIG. 1), namely a remainder of side strut 44.

Longitudinal side segment 102 extends further downwardly away from top taper portion 116 forming bumper surface 120 facing in an exterior direction away from the opposite side strut 44. Bumper surface 120 may take on any suitable configuration, for example, a substantially planar configuration, for instance, a substantially vertical configuration, as shown in FIG. 7, or an alternative convex configuration for bumper surface 120′ as shown in broken lines for an alternative longitudinal side segment 120′ of a bumper 24′, or other suitable configuration as will be apparent to those of skill in the art. Bumper surface 120 is configured to take on first contact with objects outside of shopping cart 10 that may be contacted during use of shopping cart 10, such as fixtures, other shopping carts, displays, point-of-sale assemblies, walls, retails products for sale, product carts, other shoppers, etc. to protect or at least partially deter contact with a remainder of shopping cart 10 that could deter from its original aesthetic appeal.

In one example, exterior surface 110 additionally includes a bottom taper portion 118 extending between longitudinal side segment 102 and bottom 114 of side strut 44. Bottom taper portion 118 angles from a bottom of longitudinal side segment 102 downwardly and inwardly to create a distance D_{B} between longitudinal side segment 102 of bumper 24 and a remainder of chassis 12 (FIG. 1), namely a remainder of side strut 44. In this way, top taper portion 116 and bottom taper portion 118 collectively work to distance longitudinal side segment 102 of bumper 24 from a remainder of chassis 12, in particular, from a remainder of side strut 44. Distances D_{A} and D_{B} provide a buffer of space against impact from surrounding objects 170 (see, e.g., FIGS. 10 and 11) such that when longitudinal side segment 102 of bumper 24 contacts such objects 170, a remainder of side strut 44, and therefore, a remainder of chassis 12, are maintained spaced away from such object 170 as will be further described below.

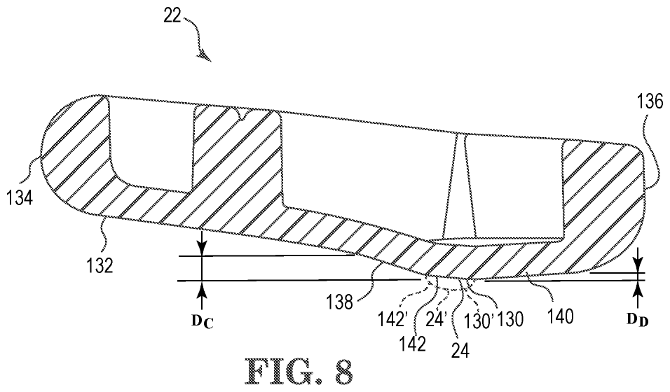

Referring FIGS. 1-6 and additionally to the cross-sectional view of FIG. 8 taken about the line 8-8 in FIG. 1, in one embodiment, each of support masts 22 defines an exterior facing surface 132 extending between a front 134 and a rear 136 of support mast 22 opposite front 134. Support masts 22 may be hollow as shown in FIG. 8 or, in other embodiments, is solid or otherwise formed. Exterior surface 132 defines a front taper portion 138, upright segment 130 of bumper 24, and rear taper portion 140, in one embodiment. More specifically, in one example, exterior surface 132 extends rearwardly from front 134 to front taper portion 138, where exterior surface 132 angles rearwardly and further outwardly away from front 134, and away from compartment 86, to one of upright segments 130 of bumper 24. In this manner, a distance D_{C} is created between upright segments 130 of bumper 24 and a remainder of chassis 12 (FIG. 1), namely a remainder of support mast 22.

Upright segments 130 extends further downwardly away from front taper portion 138 forming bumper surface 142 facing in an exterior direction away from the opposite support mast 22. Bumper surface 142 may take on any suitable configuration, for example, a substantially planar configuration, as shown in FIG. 7, or an alternative convex configuration for bumper surface 142′ as shown in broken lines for an alternative upright segment 130′ of a bumper 24′, or other suitable configuration as will be apparent to those of skill in the art. Bumper surface 142 is configured to take on first contact with objects outside of shopping cart 10 that may be contacted during use of shopping cart 10, such as fixtures, other shopping carts, displays, point-of-sale assemblies, walls, retails products for sale, product carts, other shoppers, etc. to protect or at least partially deter contact with a remainder of shopping cart 10 that could deter from its original aesthetic appeal.

In one example, exterior surface 132 additionally includes a rear taper portion 140 extending between upright segment 130 and rear 136 of support mast 22. Rear taper portion 140 angles from a rear of upright segment 130 rearwardly and inwardly to create a distance D_{D} between upright segment 130 of bumper 24 and a remainder of chassis 12 (FIG. 1), namely a remainder of support mast 22. In this way, front taper portion 138 and rear taper portion 140 collectively work to distance upright segment 130 of bumper 24 from a remainder of chassis 12, in particular, from a remainder of support mast 22. Distances D_{C} and D_{D} provide a buffer of space against impact from surrounding objects 170 (see, e.g., FIGS. 10 and 11) such that when upright segment 130 of bumper 24 contacts such objects 170, a remainder of support mast 22, and therefore, a remainder of chassis 12, are maintained spaced away from such object 170 as will be further described below.

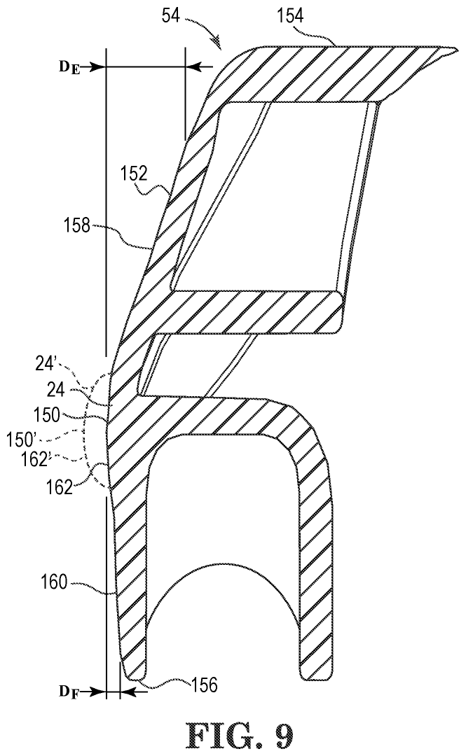

Referring FIGS. 1-6 and additionally to the cross-sectional view of FIG. 9 taken about the line 9-9 in FIG. 1, in one embodiment, each of rear leg 54 defines an exterior facing surface 152 extending between a top 154 and a bottom 156 of rear leg 54 opposite top 154. Rear leg 54 may be substantially hollow as shown in FIG. 9 or, in other embodiments, is solid or otherwise formed. Exterior surface 152 defines a front taper portion 158, rearward segment 150 of bumper 24, and rear taper portion 160, in one embodiment. More specifically, in one example, exterior surface 152 extends rearwardly from top 154 to front taper portion 158, where exterior surface 152 angles rearwardly and further outwardly away from front 134, and away from compartment 86, to one of rearward segments 150 of bumper 24. In this manner, a distance D_{E} is created between rearward segments 150 of bumper 24 and a remainder of chassis 12 (FIG. 1), namely a remainder of rear leg 54.

Rearward segments 150 extends further downwardly away from front taper portion 158 forming bumper surface 162 facing in an exterior direction away from the opposite rear leg 54. Bumper surface 162 may take on any suitable configuration, for example, a substantially planar configuration, as shown in FIG. 9, or an alternative convex configuration for bumper surface 162′ as shown in broken lines for an alternative rearward segment 150′ of a bumper 24′, or other suitable configuration as will be apparent to those of skill in the art. Bumper surface 162 is configured to take on first contact with objects outside of shopping cart 10 that may be contacted during use of shopping cart 10, such as fixtures, other shopping carts, displays, point-of-sale assemblies, walls, retails products for sale, product carts, other shoppers, etc. to protect or at least partially deter contact with a remainder of shopping cart 10 that could deter from its original aesthetic appeal.

In one example, exterior surface 152 additionally includes a rear taper portion 160 extending between rearward segment 150 and bottom 156 of rear leg 54. Rear taper portion 160 angles from a rear of rearward segment 150 rearwardly and inwardly to create a distance D_{F} between rearward segment 150 of bumper 24 and a remainder of chassis 12 (FIG. 1), namely a remainder of rear leg 54. In this way, front taper portion 158 and rear taper portion 160 collectively work to distance rearward segment 150 of bumper 24 from a remainder of chassis 12, in particular, from a remainder of rear leg 54. Distances D_{E} and D_{F} provide a buffer of space against impact from surrounding objects 170 (see, e.g., FIGS. 10 and 11) such that when rearward segment 150 of bumper 24 contacts such objects 170, a remainder of rear leg 54, and therefore, a remainder of chassis 12, are maintained spaced away from such object 170 as will be further described below.

The angle orientations of taper portions 116, 118, 138, 140, 158, and 160 relative to the what would otherwise be substantially planar expanse across each of the respective front cross bar 40, side strut 44, side mast 22, or rear leg 54 is between about 10 degrees and about 40 degrees to create distancing between bumper 24 to object 170 contact and a remainder of chassis 12.

FIGS. 10 and 11 illustrate examples of shopping cart 10 interaction with external objects 170 such as a wall, although similar principles hold true for fixtures and other objects shopping cart 10 may interact with during use. For example, FIG. 10 illustrates rearward segment 150 of bumper 24 interacting with object 170, more particularly, with exterior bumper surface 162 of rearward segment 150 interacting with object 170 such that due to distances D_{E} and D_{F} a remainder of rear leg 54 is maintained spaced away from object 170 such that the remainder of rear leg 54 is unmarred by object 170 since rear leg 54 does not contact object 170. In one example, depending upon the design of the components of shopping cart 10 as a whole, bumper 24 may also server to further space other portions of shopping cart 10, such as basket 14, support mast 22, handle assembly 16, etc. further away from object 170 as well also decreasing the likelihood that object 170 will cause any unwanted damages to those portions of the shopping cart 10 in addition to rear leg 54. In one example, where bumper 24 or portions thereof are formed of a plastic or other moldable material, such as those described above, the materials may be damaged along bumper 24 upon contact with object 170 or upon repeated contact with differing objects 170. However, the limited dimensional height of bumper 24 limits the visual impact of any aesthetic impact of the damage on the overall visual appeal of shopping cart 10.

Similarly, FIG. 11 illustrates a portion of shopping cart 10, including front segment 100 of bumper 24, interacting with object 170, more particularly, with exterior bumper surface 120 of front segment 100 interacting with object 170 such that a remainder of front cross bar 40, and frame 38 as a whole, is maintained spaced away from object 170. In this manner, the remainder of front cross bar 40 is unmarred by object 170 since front cross bar 40 does not contact object 170. In one example, depending upon the design of the components of shopping cart 10 as a whole, bumper 24 may also server to further space other portions of shopping cart 10, such as basket 14, support mast 22, handle assembly 16, etc. further away from object 170 as well also decreasing the likelihood that object 170 will cause any unwanted damages to those portions of the shopping cart 10 in addition to front cross bar 40. In one example, where bumper 24 or portions thereof are formed of a plastic or other moldable material, such as those described above, the materials may be damaged along bumper 24 upon contact with object 170 or upon repeated contact with differing objects 170. However, the limited dimensional height of bumper 24 limits the visual impact of any aesthetic impact of the damage on the overall visual appeal of shopping cart 10.

As described above, a shopping cart according to embodiments of the present invention includes a chassis, wheels, and a basket. The chassis includes a base frame and support masts extending upwardly from the base frame. The wheels are coupled to the chassis. The basket is supported by the support masts to extend over the chassis, wherein the basket defines a compartment for selectively storing items. The base frame defines an exterior facing surface having a bumper extending outwardly away from a remainder of the exterior facing surface providing a buffer of space between an exterior bumper surface and a remainder of the base frame. In different embodiments, the bumper extends axially along a length of one or more of a front cross bar or side strut of the base frame, the support masts, and/or the rear wheels providing spacing from any object that may be contacted and contact between that object and any other portion of the shopping cart other than the bumper. In this manner, bumper takes on the contact and any of the damage that contact with object(s) may cause limiting the aesthetic impairment to the shopping cart to the relatively small part of the cart that forms the bumper. As such, the overall aesthetic integrity and lifespan of a shopping cart can be increased.

Although the invention has been described with respect to particular embodiments, such embodiments are meant for illustrative purposes only and should not be considered to limit the invention. Various alternatives and changes will be apparent to those of ordinary skill in the art upon reading this application. Other modifications within the scope of the invention and its various embodiments will be apparent to those of ordinary skill.

What is claimed is:

1. A shopping cart comprising:
a chassis including a base frame and support masts extending upwardly from the base frame;
wheels coupled to the chassis; and
a basket supported by the support masts to extend over the chassis, wherein the basket defines a compartment for selectively storing items;
wherein the base frame defines an exterior facing surface having a bumper extending outwardly away from a reminder of the exterior facing surface providing a buffer of space between an exterior bumper surface and a remainder of the base frame.

2. The shopping cart of claim 1, wherein the base frame defines a side strut extending between a front of the base frame and a rear of the base frame, the side strut defining a top a and a bottom of the side strut, the bumper is positioned between the top and the bottom of the side strut.

3. The shopping cart of claim 2, wherein the bumper extends substantially parallel with the top of the side strut for a length of the bumper.

4. The shopping cart of claim 2, wherein the exterior facing surface includes a top taper portion extending outwardly between the top and the bumper and a bottom taper portion extending outwardly between the bottom and the bumper.

5. The shopping cart of claim 2, wherein a top distance between the top and the bumper and a bottom distance between the bottom and the bumper are both larger than a height of the bumper.

6. The shopping cart of claim 1, wherein:
the bumper includes a longitudinal side segment and an upright segment,
the longitudinal side segment extends from the exterior facing surface of the base frame, and
the upright segment extends from an exterior facing surface defined by one of the support masts.

7. The shopping cart of claim 6, wherein the upright segment of the bumper extends away from the exterior facing surface defined by one of the support masts and the exterior facing surface defined by one of the support masts tapers outwardly on either side of the upright segment.

8. The shopping cart of claim 6, wherein the bumper continuously extends from the longitudinal side segment and the upright segment.

9. The shopping cart of claim 1, wherein the bumper is integrally molded as a single piece with the base frame and the support mast.

10. The shopping cart of claim 1, wherein:
the base frame includes two opposing side struts and two rear legs,
each of the rear legs extends downwardly from a different one of the two opposing side struts;
the bumper includes a longitudinal side segment extending along a length of one of the two opposing the side struts and a rearward segment extending downwardly along a length of the one of the rear legs extending downwardly from the one of the two opposing side struts; and
the bumper is continuous from the longitudinal side segment to the rearward segment.

11. The shopping cart of claim 10, wherein:
the rear leg defines an exterior facing surface,
the rearward segment of the bumper extends along an interior portion of the exterior facing surface; and
the exterior facing surface tapers outwardly to the rearward segment on both sides of the rearward segment of the bumper.

12. The shopping cart of claim 10, wherein:
the bumper includes an upright segment extending from an exterior facing surface defined by one of the support masts upwardly along a length of the one of the support masts.

13. The shopping cart of claim 12, wherein the upright segment of the bumper extends away from the exterior facing surface defined by one of the support masts and the exterior facing surface defined by one of the support masts tapers outwardly on either side of the upright segment.

14. The shopping cart of claim 12, wherein the bumper continuously extends to form the longitudinal side segment, the rearward segment, and the upright segment.

15. The shopping cart of claim 11, wherein the bumper is integrally molded as a single piece with the base frame and the support mast.

16. A method of decreasing damage to a shopping cart, the method comprising:
providing the shopping cart including:
a chassis including a base frame and support masts extending upwardly from the base frame,
wheels coupled to the chassis, and
a basket supported by the support masts to extend over the chassis, wherein the basket defines a compartment for selectively storing items,
wherein the base frame defines an exterior facing surface having a bumper extending outwardly away from a reminder of the exterior facing surface providing a buffer of space between an exterior bumper surface and a remainder of the base frame; and
moving the shopping cart through a retail space until the exterior bumper surface contacts an object external to the shopping cart, the bumper being sized and shaped to maintain the exterior facing surface and a remainder of the base frame spaced from the object.

17. The method of claim 16, wherein providing the shopping cart includes providing an upright segment of the bumper to extend along at least one of the support masts in a manner providing a protective buffer zone against damage from the object to a remainder of the at least one of the support masts other than the upright segment.

18. The method of claim 16, wherein providing the shopping cart includes providing a rearward segment of the bumper to extend continuously from a longitudinal side segment of the bumper extending along a side of the base frame, the rearward segment extending downwardly along a rear leg of the chassis where the rear leg of the chassis extends downwardly from the base frame of the shopping cart and is coupled to one of the wheels.

19. The method of claim 18, wherein providing the shopping cart includes injection molding the base frame as a single piece including the rear leg and the bumper.

20. The method of claim 16, wherein providing the shopping cart includes providing a rearward segment of the bumper to extend continuously from a longitudinal side segment of the bumper extending along a side of the base frame, the rearward segment extending downwardly along a rear leg of the chassis where the rear leg of the chassis extends downwardly from the base frame of the shopping cart and is coupled to one of the wheels.
